(19) United States
(12) Patent Application Publication
(10) Pub. No.: US 2005/0090568 A1
(43) Pub. Date: Apr. 28, 2005

(54) Polymethacrylimide plastic foam materials with reduced inflammability in addition to a method for the production thereof

(76) Inventors: Peter Stein, Traisa (DE); Werner Geyer, Muehltal (DE); Thomas Barthel, Heppenheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/498,973

(22) PCT Filed: Jan. 15, 2003
(86) PCT No.: PCT/EP03/00337

(30) Foreign Application Priority Data
Feb. 28, 2002 (DE) 102 08 684.2
Apr. 16, 2002 (DE) 101 17 005.3

(51) Int. Cl. C08J 9/00

(52) U.S. Cl. 521/50

(57) ABSTRACT

The present invention relates to compositions for producing poly(meth)acrylimide foams having reduced flammability which comprise ammonium polyphosphate and/or zinc sulphide. Furthermore, the present invention also provides poly(meth)acrylimide moulding compositions and also poly(meth)acrylimide foams obtainable from the abovementioned compositions and moulding compositions. The present invention further relates to processes for producing poly(meth)acrylimide foams having reduced flammability.

### FIELD OF THE INVENTION

The invention relates to compositions for producing polymethacrylimide foams having reduced flammability, to polymethacrylimide moulding compositions, polymethacrylimide foams and also to processes for producing the abovementioned products.

### PRIOR ART

Polymethacrylimide foams have been known for some time and, owing to their outstanding mechanical properties and their light weight, find a wide range of use, in particular in preparing layered materials, laminates, composites, or foam composites. Prepregs are frequently combined with polymethacrylimide core materials.

For example, prepregs are used in aircraft building, shipbuilding and also in buildings. For many of these numerous applications, they have to satisfy fire protection requirements laid down in statutory directives and a series of other regulations.

To prove that the foams satisfy the fire protection requirements, a variety of different fire tests are carried out which are customarily directed to the use of the foam or the composite containing it. In general, it is necessary to provide the polymethacrylimide foams with flame retardants so that these tests are passed.

The use of chlorine or bromine compounds as flame retardants is widely known. These compounds are frequently used together with antimony oxides. However, a disadvantage is that polymethacrylimides whose flammability is reduced in this way can only be very poorly recycled, since these halohydrocarbons can scarcely be removed from the polymer and, in waste incineration plants, dioxins can form from these compounds.

Furthermore, in the event of fire, poisonous gases, for example, HCl and HBr, are formed. Owing to these disadvantages, it is a general aim to very substantially avoid chlorinated and brominated substances as additives in plastics.

Phosphorus compounds are a further substance class of flame retardants with which polymethacrylimide foams are provided. However, a particular disadvantage is that fire results in a very high smoke density which likewise occurs in the case of halogenated flame retardants. Owing to its toxicity, this smoke on the one hand endangers people who breathe in these gases and on the other hand hampers rescue work.

In addition, many of the phosphorus compounds used as flame retardants function as plasticizers. This undesired effect limits the amount of phosphorus compounds added.

Furthermore, the flame-retardant polymethacrylimide foams known hitherto do not fulfil all of the fire protection standards required for certain applications. For example, although existing foams which are obtained according to DE-A 33 46 060, EPA 0 146 892 or U.S. Pat. No. 4,576,971 are self-extinguishing, they comply only unsatisfactorily, if at all, with the vertical flame test 60s according to FAR 25.853(a) (1) (i) or the smoke density test according to FAR 25.853(c), AITM 2.0007 and exhibit high heat development according to FAR 25.853(c). In this connection, there is in particular a remarkably high dependency upon the density of the test sample. Although foams having high density sometimes pass the vertical flame test 60s, they exhibit very high heat development. The abovementioned materials do not pass the fire test for rail vehicles according to DIN 54837.

The PMI foams described in the German patent application no. 10052239.4 are also unsatisfactory in relation to their flame resistance. The formulations having expandable graphite cited there lead to foams which firstly release too large an amount of heat during the combustion (the amount of heat released corresponds to twice the amount allowed according to FAR 25.853(c)) and secondly lack mechanical stability in comparison to PMI foams existing on the market. Further, the expandable graphite used for flame retardancy cannot be introduced into the material homogeneously, since the use of a dispersant comminutes the expandable graphite particles and thus distinctly reduces the flame retardancy. (It is generally known that the expanding action of expandable graphite reduces with falling particle size and the flame retardancy is thus worsened.) The nonhomogeneous foam slabs have to be manually straightened, which however leads to very many rejects owing to material fracture, i.e. ˜80% of the foam slabs produced cannot be used for application purposes.

Object

In view of the prior art cited and discussed herein, it is an object of the present invention to provide compositions for producing polymethacrylimide foams having reduced flammability, polymethacrylimide moulding compositions and also polymethacrylimide foams which exhibit low smoke development according to FAR 25.853(c), AITM 2.0007 and also low heat development according to FAR 25.853(c). Furthermore, the foams shall pass the vertical flame test 60s according to FAR 25.853(a)(1)(i).

Another problem is to provide polymethacrylimide foams which satisfy the standards of the fire test for rail vehicles according to DIN 54837.

Another object of the invention is to provide polymethacrylimide foams having reduced flammability which comprise reduced amounts of phosphorus compounds or halogenated hydrocarbons.

A further object of the invention is to provide a very inexpensive flame retardant for polymethacrylimides and/or polymethacrylimide foams.

Furthermore, it is therefore an object of the present invention that the flame retardant used to treat the polymethacrylimides or polymethacrylimide foams shall be very substantially acceptable under health considerations. The mechanical properties of the foams according to the invention shall further not be adversely affected by the additives.

Solution

The abovementioned object can be achieved by foams which are prepared according to the process described in the German patent application no. 10113899.7. This quite generally discloses a means of introducing insoluble additives into PMI foams produced by the cell process. However, the disclosed formulations provide no application utility.

When the additives used are ammonium polyphosphate or combinations of ammonium polyphosphate and zinc sulphide, the PMI foams obtained have a distinctly reduced heat emission according to FAR 25.853(c). The amount of ammonium polyphosphate alone which is used, based on the total amount of monomers, is between 0.1 and 350% by weight of ammonium polyphosphate, preferably between 5 and 200% by weight of ammonium polyphosphate and more preferably between 25 and 150% by weight of ammonium polyphosphate.

The amount of zinc sulphide alone which is used, based on the total amount of monomers, is between 0.1-20% by weight of zinc sulphide, preferably between 0.5-10% by weight of zinc sulphide and more preferably between 1-5% by weight of zinc sulphide.

When both substances are used as a mixture, the ammonium polyphosphate content is 1-300% by weight and the zinc sulphide content is 0.1-20% by weight, preferably 5-200% by weight of ammonium polyphosphate and 0.5-10% by weight of zinc sulphide and more preferably 25-150% by weight of ammonium polyphosphate and 1-5% by weight of zinc sulphide.

Ammonium polyphosphates (NH₄PO₃)ₙ (n=20 to approx. 1000) are the condensation products of the corresponding orthophosphates. The use of these water-insoluble compounds as flame retardants for paints, synthetic resins and wood is known (Römpp, 10th Edition, (1996), Ullmann, 4th Edition (1979)).

Further flame retardants may optionally be used individually or in mixtures. Examples of further flame retardants that may be used include phosphorus compounds, for example, phosphines, phosphine oxides, phosphonium compounds, phosphonates, phosphites or phosphates.

In addition to ammonium polyphosphate and zinc sulphide, the composition according to the invention may comprise further flame retardants in order to additionally reduce flammability. These flame retardants are widely known to those skilled in the art. In addition to halogenated flame retardants which sometimes comprise antimony oxides, phosphorus compounds may also be used. Owing to the better recyclability of the plastics, preference is given to phosphorus compounds.

Phosphorus compounds include phosphines, phosphine oxides, phosphonium compounds, phosphonates, phosphites and/or phosphates. These compounds may be of organic and/or inorganic nature, and include derivatives of these compounds, for example, phosphoric monoesters, phosphonic monoesters, phosphoric diesters, phosphonic diesters and phosphoric triesters and also polyphosphates.

Preference is given to phosphorus compounds of the formula (I)
X—CH₂—P(O)(OR)₂ (I)
where each R is an identical or different radical from the group of methyl, ethyl and chloromethyl, and X is a hydrogen or halogen atom, a hydroxyl group or an R¹O—CO— group where R¹ is methyl, ethyl or chloromethyl.

Examples of phosphorus compounds of the formula (I) include dimethyl methanephosphonate (DMMP), diethyl methanephosphonate, dimethyl chloromethanephosphonate, diethyl chloromethanephosphonate, dimethyl hydroxymethanephosphonate, diethyl hydroxymethanephosphonate, dimethyl methoxycarbonylmethanephosphonate and diethyl ethoxycarbonylmethanephosphonate.

The phosphorus compounds may be used individually or as a mixture. Preference is given in particular to mixtures which comprise phosphorus compounds of the formula (I).

These compounds may be used up to a proportion of 25% by weight, based on the weight of the monomers, in order to satisfy the fire protection standards. In preferred embodiments, the proportion of phosphorus compounds is in the range from 1-15% by weight, although this is not intended to imply any restriction. The use of increasing amounts of these compounds may worsen the other thermal and mechanical properties of the plastics, for example the compressive strength, the flexural strength and heat distortion resistance.

Compositions according to the invention for producing poly(meth)acrylimide foams are polymerizable mixtures which comprise at least one, customarily two or more, monomers, for example (meth)acrylic acid and (meth)acrylonitrile, blowing agent, at least one polymerization initiator and ammonium polyphosphate and/or zinc sulphide, with or without further flame retardants. These compositions are polymerized to precursors from which poly(meth)acrylimide foams are formed by heating.

The notation in brackets is intended to indicate an optional feature. For example, (meth)acrylic means acrylic, methacrylic and mixtures of both.

The poly(meth)acrylimide foams obtainable from the compositions according to the invention have repeating units which can be represented by formula (II) 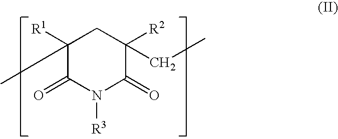
wherein
R¹ and R² are the same or different and are each hydrogen or a methyl group, and R³ is hydrogen or an alkyl or aryl radical having up to 20 carbon atoms.

Units of the structure (II) preferably form more than 30% by weight, more preferably more than 50% by weight and most preferably more than 80% by weight, of the poly(meth)acrylimide foam.

The production of rigid poly(meth)acrylimide foams is known per se and is disclosed, for example, in GB Patent 1 078 425, GB Patent 1 045 229, DE Patent 1 817 156 (=U.S. Pat. No. 3,627,711) or DE Patent 27 26 259 (=U.S. Pat. No. 4,139,685).

For instance, one way of forming the units of the structural formula (II) from neighbouring units of (meth)acrylic acid and (meth)acrylonitrile is by a cyclizing isomerization reaction on heating to 150 to 250° C. (cf. DE-C 18 17 156, DE-C 27 26 259, EP-B 146 892). Customarily, a precursor is initially obtained by polymerizing the monomers in the presence of a radical initiator at low temperatures, for example 30 to 60° C. with post-heating to 60 to 120° C. and the precursor is then foamed by a blowing agent present on heating to approx. 180 to 250° C. (see EP-B 356 714).

To this end, for example, a copolymer may initially be formed which comprises (meth)acrylic acid and (meth)acrylonitrile, preferably in a molar ratio between 1:4 and 4:1.

Furthermore, these copolymers may comprise further monomer units which, for example, arise from esters of acrylic or methacrylic acid, in particular with lower alcohols having 1-4 carbon atoms, styrene, maleic acid or anhydride, itaconic acid or anhydride, vinylpyrrolidone, vinyl chloride or vinylidene chloride. The proportion of comonomers which can only be cyclized with great difficulty, if at all, should not exceed 30% by weight, preferably 20% by weight and more preferably 10% by weight, based on the weight of the monomers.

Further polymers which can likewise be used advantageously in a known manner include small amounts of crosslinkers, for example, allyl acrylate, allyl methacrylate, ethylene glycol diacrylate or dimethacrylate or polyvalent metal salts of acrylic or methacrylic acid, such as magnesium methacrylate. The proportions of these crosslinkers are frequently in the range from 0.005 to 5% by weight, based on the total amount of polymerizable monomers.

Furthermore, metal salt additives may be used. These include the acrylates or methacrylates of alkaline earth metals or zinc. Preference is given to zinc (meth)acrylate and magnesium (meth)acrylate. The polymerization initiators used are those which are themselves customary for the polymerization of (meth)acrylates, for example azo compounds such as azodiisobutyronitrile, and also peroxides such as dibenzoyl peroxide or dilauroyl peroxide, or else other peroxide compounds, for example, t-butyl peroctanoate or perketals, or else optionally redox initiators (on this subject, cf., for example, H. Rauch-Puntigam, Th. Völker, Acryl- und Methacrylverbindungen, Springer, Heidelberg, 1967 or Kirk-Othmer, Encyclopedia of Chemical Technology, Vol. 1, pages 286 ff, John Wiley & Sons, New York, 1978). Preference is given to using the polymerization initiators in amounts of from 0.01 to 0.3% by weight, based on the total weight of the monomers used.

It may also be advantageous to combine polymerization initiators having differing decomposition properties with regard to time and temperature. It is highly suitable, for example, to use at the same time tert-butyl perpivalate, tert-butyl perbenzoate and tert-butyl per-2-ethylhexanoate, or tert-butyl perbenzoate, 2,2-azobisiso-2,4-dimethylvaleronitrile, 2,2-azobisiso-butyronitrile and di-tert-butyl peroxide.

The polymerization is preferably effected via variants of bulk polymerization, for example, the cell process, without being restricted to them.

The weight average molecular weight \overline{M}_{w} of the polymers is preferably greater than 10⁶ g/mol, in particular greater than 3×10⁶ g/mol, although no restriction is intended.

During the conversion to an imide-containing polymer, blowing agents which form a gas phase by decomposition or evaporation at 150 to 250° C. serve in a known manner to foam the copolymer. On decomposition, blowing agents having amide structure, such as urea, monomethyl- or N,N′-dimethylurea, formamide or monomethylformamide release ammonia or amines which can contribute to additional formation of imide groups. However, it is also possible to use nitrogen-free blowing agents such as formic acid, water or monohydric aliphatic alcohols having 3 to 8 carbon atoms such as 1-propanol, 2-propanol, n-butan-1-ol, n-butan-2-ol, isobutan-1-ol, isobutan-2-ol, tert-butanol, pentanols and/or hexanols. The amount of blowing agent used is determined by the desired foam density, and the blowing agents in the reaction batch are customarily used in amounts of approx. 0.5 to 15% by weight, based on the total weight of the monomers used.

The precursors may further comprise customary additives. These include antistats, antioxidants, mould release agents, lubricants, dyes, flame retardants, flow improvers, fillers, light stabilizers and organic phosphorus compounds such as phosphites or phosphonates, pigments, release agents, weathering protectants and plasticizers.

Conductive particles which prevent electrostatic charging of the foams are a further class of preferred additives. These include metal and carbon black particles which may also be in the form of fibres and have a size in the range from 10 nm to 10 mm, as described in EP 0 356 714 A1.

Furthermore, anti-settling agents are preferred additives, since these materials efficiently stabilize the compositions for producing polyacrylimide foams. These include carbon blacks, for example, KB EC-600 JD from Akzo Nobel, and Aerosils, for example, Aerosil 200 from Degussa AG, or thickeners based on polymers, for example, high molecular weight polymethyl methacrylate.

A poly(meth)acrylimide foam according to the invention may be produced, for example, by polymerizing a mixture consisting of
(A) 20-60% by weight of (meth)acrylonitrile,
   40-80% by weight of (meth)acrylic acid and
   0-20% by weight of further vinylically unsaturated monomers, the constituents of the components (A) adding up to 100% by weight;
(B) 0.5-15% by weight, based on the weight of the components (A), of a blowing agent;
(C) 1-50% by weight, based on the weight of the components (A), of ammonium polyphosphate and/or zinc sulphide;
(D) 0.01-0.3% by weight, based on the weight of the components (A), of a polymerization initiator;
(E) 0-200% by weight, based on the weight of the components (A), of customary additives
   to give a slab and then foaming this polymer slab at temperatures of 150 to 250° C.

A further aspect of the present invention is poly(meth)acrylimide moulding compositions having reduced flammability which comprise ammonium polyphosphate and/or zinc sulphide. These thermoplastically processable moulding compositions comprise poly(meth)acrylimides having high heat distortion resistance which may be obtained, for example, by reacting polymethyl methacrylate or its copolymers with primary amines. The following are representative examples of this polymer-like imidation; U.S. Pat. No. 4,246,374, EP 216 505 A2, EP 860 821. High heat distortion resistance can be achieved either by the use of arylamines (JP 05222119 A2) or by the use of special comonomers (EP 561 230 A2, EP 577 002 A1). All of these reactions result in solid polymers which may be foamed in a separate second step to obtain a foam using suitable techniques known to those skilled in the art.

Poly(meth)acrylimide moulding compositions according to the invention comprise as essential constituent flame-retardant ammonium polyphosphate and/or zinc sulphide. Preference is given to using this constituent in the above-detailed amounts.

Furthermore, these moulding compositions may comprise the abovementioned optional additives. They may be provided with ammonium polyphosphate and/or zinc sulphide before, during or after the polymerization or imidation by known processes.

As previously mentioned, these moulding compositions may be foamed with the aid of known techniques. One way of achieving this is to use the abovementioned blowing agents which, for example, may be added to the moulding compositions by compounding.

Poly(meth)acrylimide foams according to the invention may be provided with covering layers, in order to increase, for example, the strength. Furthermore, layered materials are known which, owing solely to the choice of the covering material, offer a certain flame retardancy. When the foams according to the invention are used, the fire resistance which is achieved by using these composite materials can be distinctly increased.

The covering layer used may be any known sheet-like structure which is stable under the processing parameters such as pressure and temperature which are necessary for preparing the composite structure. Examples include films and/or sheets which comprise polypropylene, polyester, polyether, polyamide, polyurethane, polyvinyl chloride, polymethyl (meth)-acrylate, plastics obtained by curing reactive resins, for example epoxide resins (EP resins), methacrylate resins (MA resins), unsaturated polyester resins (UP resins), isocyanate resins and phenacrylate resins (PHA resins), bismaleimide resins and phenol resins, and/or metals, for example aluminium. Preference is further given to the covering layer being a mat or web which comprises glass fibres, carbon fibres and/or aramid fibres, and the covering layer may also be a web which has a multi-layered structure.

One way of applying these fibre-containing webs to the foams is as prepregs. These are fibre mats, usually glass fibre mats or glass filament wovens, which have been preimpregnated with curable plastics and can be processed to give mouldings or semi-finished products by hot pressing. These include GMT and SMC.

Carbon fibre-strengthened plastics are also known which are particularly suitable as covering layers.

The thickness of the covering layer is preferably in the range from 0.1-100 mm, with preference in the range from 0.5-10 mm.

To improve the adhesion, an adhesive may also be used. However, depending on the material of the covering layer, this may not be necessary.

The poly(meth)acrylimide foams according to the invention and in particular the layered materials comprising these foams may be used, for example, in aircraft building and in the building of ships or rail vehicles.

The foams produced in this way further pass the smoke density test according to FAR 25.853(c), AITM 2.0007, the requirement of the vertical flame test according to FAR 25.853(a)(1)(i) and the toxicity requirement according to AITM 3.0005. In contrast to the expandable-graphite-filled systems, a homogeneous particle distribution is possible, so that these foam slabs can be processed by the generally known means with regard to the PMI foams customary on the market.

### EXAMPLES

### Example 1

1000 g (10.0 parts by weight) of isopropanol were added as a blowing agent to a mixture of 5000 g of methacrylic acid (50.0 parts by weight) and 5000 g of methacrylonitrile (50.0 parts by weight). Also added to the mixture were 20 g (0.20 part by weight) of tert-butyl perpivalate, 3.6 g (0.036 part by weight) of tert-butyl per-2-ethyl-hexanoate, 10 g (0.10 part by weight) of tert-butyl perbenzoate, 400 g (4.0 parts by weight) of Degalan BM 310 (high molecular weight polymethyl methacrylate), 0.5 g (0.005 part by weight) of benzoquinone and 32.0 g (0.32 part by weight) of PAT 1037 as release agent. (Sales: E. and P. Würtz GmbH & Co. KG, Industriegebiet, In der Weide 13+18, 55411 Bingen, Sponsheim.)

The flame retardants added to the mixture were 10,000 g (100.0 parts by weight) of APP2 (ammonium polyphosphate) from Nordmann, Rassmann GmbH & Co. and 125 g (1.25 parts by weight) of Flameblock 10.0R (zinc sulphide) from Sachtleben. The mixture was stirred until homogeneous and then polymerized at 42° C. for 19.25 h in a cell formed from two glass plates of size 50×50 cm and an edge seal of thickness 1.85 cm. For completing polymerization, the polymer was then subjected to a heating programme ranging from 40 to 115° C. for 17.25 h. The subsequent foaming was effected at 180° C. for 2 h.

The foam obtained in this way had a density of 72 kg/m³. The heat release according to FAR 25.853(c) was HR=79 kWmin/m² and HRR=75 Kw/m².

The foam produced in this way also passes the smoke density test according to FAR 25.853(c), AITM 2.0007, the requirement of the vertical flame test according to FAR 25.853(a)(1)(i) and the toxicity requirement according to AITM 3.0005.

### Example 2

1000 g (10.0 parts by weight) of isopropanol were added as a blowing agent to a mixture of 5000 g of methacrylic acid (50.0 parts by weight) and 5000 g of methacrylonitrile (50.0 parts by weight). Also added to the mixture were 20 g (0.20 part by weight) of tert-butyl perpivalate, 3.6 g (0.036 part by weight) of tert-butyl per-2-ethyl-hexanoate, 10 g (0.10 part by weight) of tert-butyl perbenzoate, 400 g (4.0 parts by weight) of Degalan BM 310 (high molecular weight polymethyl methacrylate), 0.5 g (0.005 part by weight) of benzoquinone and 32.0 g (0.32 part by weight) of PAT 1037 as release agent.

The flame retardants added to the mixture were 10,000 g (100.0 parts by weight) of APP2 (ammonium polyphosphate) from Nordmann, Rassmann GmbH & Co. and 250 g (2.5 parts by weight) of Flameblock 10.0R (zinc sulphide) from Sachtleben. The mixture was stirred until homogeneous and then polymerized at 42° C. for 20 h in a cell formed from two glass plates of size 50×50 cm and an edge seal of thickness 1.85 cm. For completing polymerization, the polymer was then subjected to a heating programme ranging from 40 to 115° C. for 17.25 h. The subsequent foaming was effected at 180° C. for 2 h.

The foam obtained in this way had a density of 71 kg/m³. The heat release according to FAR 25.853(c) was HR=94 kWmin/m² and HRR=80 Kw/m².

The foam produced in this way also passes the smoke density test according to FAR 25.853(c), AITM 2.0007, the requirement of the vertical flame test according to FAR 25.853(a)(1)(i) and the toxicity requirement according to AITM 3.0005.

### Example 3

1000 g (10.0 parts by weight) of isopropanol were added as a blowing agent to a mixture of 5000 g of methacrylic acid (50.0 parts by weight) and 5000 g of methacrylonitrile (50.0 parts by weight). Also added to the mixture were 20 g (0.20 part by weight) of tert-butyl perpivalate, 3.6 g (0.036 part by weight) of tert-butyl per-2-ethyl-hexanoate, 10 g (0.10 part by weight) of tert-butyl perbenzoate, 500 g (5.0 parts by weight) of Degalan BM 310 (high molecular weight polymethyl methacrylate), 0.5 g (0.005 part by weight) of benzoquinone and 32.0 g (0.32 part by weight) of PAT 1037 as release agent.

The flame retardants added to the mixture were 10,000 g (100.0 parts by weight) of APP2 (ammonium polyphosphate) from Nordmann, Rassmann GmbH & Co. and 375 g (3.75 parts by weight) of Flameblock 10.0R (zinc sulphide) from Sachtleben. The mixture was stirred until homogeneous and then polymerized at 45° C. for 19.5 h in a cell formed from two glass plates of size 50×50 cm and an edge seal of thickness 1.85 cm. For completing polymerization, the polymer was then subjected to a heating programme ranging from 40 to 115° C. for 17.25 h. The subsequent foaming was effected at 180° C. for 2 h.

The foam obtained in this way had a density of 78 kg/m³. The heat release according to FAR 25.853(c) was HR=75 kWmin/m² and HRR=78 Kw/m².

The foam produced in this way also passes the smoke density test according to FAR 25.853(c), AITM 2.0007, the requirement of the vertical flame test according to FAR 25.853(a)(1)(i) and the toxicity requirement according to AITM 3.0005.

### Example 4

1000 g (10.0 parts by weight) of isopropanol were added as a blowing agent to a mixture of 5000 g of methacrylic acid (50.0 parts by weight) and 5000 g of methacrylonitrile (50.0 parts by weight). Also added to the mixture were 20 g (0.20 part by weight) of tert-butyl perpivalate, 3.6 g (0.036 part by weight) of tert-butyl per-2-ethyl-hexanoate, 10 g (0.10 part by weight) of tert-butyl perbenzoate, 500 g (5.0 parts by weight) of Degalan BM 310 (high molecular weight polymethyl methacrylate), 0.5 g (0.005 part by weight) of benzoquinone and 32.0 g (0.32 part by weight) of PAT 1037 as release agent.

The flame retardants added to the mixture were 7500 g (75.0 parts by weight) of APP2 (ammonium polyphosphate) from Nordmann, Rassmann GmbH & Co. and 125 g (1.25 parts by weight) of Flameblock 10.0R (zinc sulphide) from Sachtleben. The mixture was stirred until homogeneous and then polymerized at 46° C. for 22.5 h in a cell formed from two glass plates of size 50×50 cm and an edge seal of thickness 1.85 cm. For completing polymerization, the polymer was then subjected to a heating programme ranging from 40 to 115° C. for 17.25 h. The subsequent foaming was effected at 180° C. for 2 h.

The foam obtained in this way had a density of 76 kg/m³. The heat release according to FAR 25.853(c) was HR=108 kWmin/m² and HRR=112 Kw/m².

The foam produced in this way also passes the smoke density test according to FAR 25.853(c), AITM 2.0007, the requirement of the vertical flame test according to FAR 25.853(a)(1)(i) and the toxicity requirement according to AITM 3.0005.

### Example 5

1000 g (10.0 parts by weight) of isopropanol were added as a blowing agent to a mixture of 5000 g of methacrylic acid (50.0 parts by weight) and 5000 g of methacrylonitrile (50.0 parts by weight). Also added to the mixture were 20 g (0.20 part by weight) of tert-butyl perpivalate, 3.6 g (0.036 part by weight) of tert-butyl per-2-ethyl-hexanoate, 10 g (0.10 part by weight) of tert-butyl perbenzoate, 500 g (5.0 parts by weight) of Degalan BM 310 (high molecular weight polymethyl methacrylate), 0.5 g (0.005 part by weight) of benzoquinone and 32.0 g (0.32 part by weight) of PAT 1037 as release agent.

The flame retardants added to the mixture were 7500 g (75.0 parts by weight) of APP2 (ammonium polyphosphate) from Nordmann, Rassmann GmbH & Co. and 375 g (3.75 part by weight) of Flameblock 10.0R (zinc sulphide) from Sachtleben. The mixture was stirred until homogeneous and then polymerized at 46° C. for 22.5 h in a cell formed from two glass plates of size 50×50 cm and an edge seal of thickness 1.85 cm. For completing polymerization, the polymer was then subjected to a heating programme ranging from 40 to 115° C. for 17.25 h.

The subsequent foaming was effected at 180° C. for 2 h.

The foam obtained in this way had a density of 79 kg/m³. The heat release according to FAR 25.853(c) was HR=113 kWmin/m² and HRR=103 Kw/m².

The foam produced in this way also passes the smoke density test according to FAR 25.853(c), AITM 2.0007, the requirement of the vertical flame test according to FAR 25.853 (a) (1) (i) and the toxicity requirement according to AITM 3.0005.

### Example 6

1000 g (10.0 parts by weight) of isopropanol were added as a blowing agent to a mixture of 5000 g of methacrylic acid (50.0 parts by weight) and 5000 g of methacrylonitrile (50.0 parts by weight). Also added to the mixture were 20 g (0.20 part by weight) of tert-butyl perpivalate, 3.6 g (0.036 part by weight) of tert-butyl per-2-ethyl-hexanoate, 10 g (0.10 part by weight) of tert-butyl perbenzoate, 500 g (5.0 parts by weight) of Degalan BM 310 (high molecular weight polymethyl methacrylate), 0.5 g (0.005 part by weight) of benzoquinone and 32.0 g (0.32 part by weight) of PAT 1037 as release agent.

The flame retardants added to the mixture were 6250 g (62.5 parts by weight) of APP2 (ammonium polyphosphate) from Nordmann, Rassmann GmbH & Co. and 125 g (1.25 parts by weight) of Flameblock 10.0R (zinc sulphide) from Sachtleben. The mixture was stirred until homogeneous and then polymerized at 42° C. for 17.5 h in a cell formed from two glass plates of size 50×50 cm and an edge seal of thickness 1.85 cm. For completing polymerization, the polymer was then subjected to a heating programme ranging from 40 to 115° C. for 17.25 h. The subsequent foaming was effected at 181° C. for 2 h.

The foam obtained in this way had a density of 77 kg/m³. The heat release according to FAR 25.853(c) was HR=116 kWmin/m² and HRR=113 Kw/m².

The foam produced in this way also passes the smoke density test according to FAR 25.853(c), AITM 2.0007, the requirement of the vertical flame test according to FAR 25.853 (a) (1) (i) and the toxicity requirement according to AITM 3.0005.

### Example 7

1000 g (10.0 parts by weight) of isopropanol were added as a blowing agent to a mixture of 5000 g of methacrylic acid (50.0 parts by weight) and 5000 g of methacrylonitrile (50.0 parts by weight). Also added to the mixture were 20 g (0.20 part by weight) of tert-butyl perpivalate, 3.6 g (0.036 part by weight) of tert-butyl per-2-ethyl-hexanoate, 10 g (0.10 part by weight) of tert-butyl perbenzoate, 500 g (5.0 parts by weight) of Degalan BM 310 (high molecular weight polymethyl methacrylate), 0.5 g (0.005 part by weight) of benzoquinone and 32.0 g (0.32 part by weight) of PAT 1037 as release agent.

The flame retardants added to the mixture were 10,000 g (100.0 parts by weight) of APP2 (ammonium polyphosphate) from Nordmann, Rassmann GmbH & Co. The mixture was stirred until homogeneous and then polymerized at 50° C. for 19.5 h in a cell formed from two glass plates of size 50×50 cm and an edge seal of thickness 1.85 cm. For completing polymerization, the polymer was then subjected to a heating programme ranging from 40 to 115° C. for 17.25 h. The subsequent foaming was effected at 185° C. for 2 h.

The foam obtained in this way had a density of 66 kg/m³. The heat release according to FAR 25.853(c) was HR=84 kWmin/m² and HRR=82 Kw/m².

The foam produced in this way also passes the smoke density test according to FAR 25.853(c), AITM 2.0007, the requirement of the vertical flame test according to FAR 25.853(a)(1)(i) and the toxicity requirement according to AITM 3.0005.

### Example 8

1000 g (10.0 parts by weight) of isopropanol were added as a blowing agent to a mixture of 5000 g of methacrylic acid (50.0 parts by weight) and 5000 g of methacrylonitrile (50.0 parts by weight). Also added to the mixture were 20 g (0.20 part by weight) of tert-butyl perpivalate, 3.6 g (0.036 part by weight) of tert-butyl per-2-ethyl-hexanoate, 10 g (0.10 part by weight) of tert-butyl perbenzoate, 500 g (5.0 parts by weight) of Degalan BM 310 (high molecular weight polymethyl methacrylate), 0.5 g (0.005 part by weight) of benzoquinone and 32.0 g (0.32 part by weight) of PAT 1037 as release agent.

The flame retardants added to the mixture were 5000 g (50.0 parts by weight) of APP2 (ammonium polyphosphate) from Nordmann, Rassmann GmbH & Co. The mixture was stirred until homogeneous and then polymerized at 45° C. for 65 h in a cell formed from two glass plates of size 50×50 cm and an edge seal of thickness 1.85 cm. For completing polymerization, the polymer was then subjected to a heating programme ranging from 40 to 115° C. for 17.25 h. The subsequent foaming was effected at 196° C. for 2 h.

The foam obtained in this way had a density of 69 kg/m³. The heat release according to FAR 25.853(c) was HR=112 kWmin/m² and HRR=112 Kw/m².

The foam produced in this way also passes the smoke density test according to FAR 25.853(c), AITM 2.0007, the requirement of the vertical flame test according to FAR 25.853 (a) (1) (i) and the toxicity requirement according to AITM 3.0005.

### Comparative Example 1

A foam having a density of 71 kg/m³ was prepared according to DE 33 46 060 using 10 parts by weight of DMMP as flame retardant.

For this example, a mixture of equal molar parts of 5620 g (56.2 parts by weight) of methacrylic acid and 4380 g (43.8 parts by weight) of methacrylonitrile had added to it 140 g (1.4 parts by weight) of formamide and 135 g (1.35 parts by weight) of water as blowing agents. Also added to the mixture were 10.0 g (0.100 part by weight) of tert-butyl perbenzoate, 4.0 g (0.0400 part by weight) of tert-butyl perpivalate, 3.0 g (0.0300 part by weight) of tert-butyl per-2-ethylhexanoate and 10.0 g (0.1000 part by weight) of cumyl perneodecanoate as initiators. Furthermore, 1000 g (10.00 parts by weight) of dimethyl methanephosphonate (DMMP) were added to the mixture as flame retardant. Finally, the mixture contained 20 g (0.20 part by weight) of release agent (MoldWiz) and 70 g (0.70 part by weight) of ZnO.

This mixture was polymerized at 40° C. for 92 h in a cell formed from two glass plates of size 50×50 cm and an edge seal of thickness 2.2 cm. For completing polymerization, the polymer was then subjected to a heating programme ranging from 40 to 115° C. for 17.25 h. The subsequent foaming was effected at 215° C. for 2 h.

The resulting foam had a density of 71 kg/m³.

The heat release according to FAR 25.853(c) was HR=211 kWmin/m² and HRR=243 Kw/m². Also, the foam prepared in this way fails the smoke density test according to FAR 25.853(c), AITM 2.0007 and also the requirement of the vertical flame test according to FAR 25.853(a)(1)(i).

### Comparative Example 2

For this example, a mixture of 5700 g (57.0 parts by weight) of methacrylic acid and 4300 g (43.0 parts by weight) of methacrylonitrile had added to it 140 g (1.4 parts by weight) of formamide and 135 g (1.35 parts by weight) of water as blowing agents. Also added to the mixture were 10.0 g (0.100 part by weight) of tert-butyl perbenzoate, 4.0 g (0.040 part by weight) of tert-butyl perpivalate, 3.0 g (0.030 part by weight) of tert-butyl per-2-ethylhexanoate and 10 g (0.100 part by weight) of cumyl perneodecanoate as initiators. Furthermore, 1000 g (10.00 parts by weight) of dimethyl methanephosphonate (DMMP) were added to the mixture as flame retardant. Finally, the mixture contained 15 g (0.15 part by weight) of release agent (PAT 1037) and 70 g (0.70 part by weight) of ZnO.

This mixture was polymerized at 40° C. for 92 h in a cell formed from two glass plates of size 50×50 cm and an edge seal of thickness 2.2 cm. For completing polymerization, the polymer was then subjected to a heating programme ranging from 40 to 115° C. for 17.25 h. The subsequent foaming was effected at 220° C. for 2 h. The resulting foam had a density of 51 kg/m³.

The heat release according to FAR 25.853(c) was HR=118 kWmin/m² and HRR=177 Kw/m². Also, the foam prepared in this way fails the smoke density test according to FAR 25.853(c), AITM 2.0007 and also the requirement of the vertical flame test according to FAR 25.853(a)(1)(i).

### Comparative Example 3

The procedure was substantially that of comparative example 1, except that the foaming was effected at 210° C. and the density of the resulting foam was as a result 110 kg/m³.

The heat release according to FAR 25.853(c) was HR=267 kWmin/m² and HRR=277 Kw/m². The foam prepared in this way also fails the smoke density test according to FAR 25.853(c), AITM 2.0007.

1-30. (canceled)

31. A composition for producing poly(meth)acrylimide foams having reduced flammability, comprising polymerizable mixtures of (meth)acrylic acid and (meth)acrylonitrile, a blowing agent, a crosslinker, at least one polymerization initiator, and ammonium polyphosphate.

32. The composition according to claim 31, wherein the ammonium polyphosphate is present in an amount from 1 to 300% by weight, based on the weight of the monomers.

33. The composition according to claim 31, wherein the ammonium polyphosphate is present in an amount from 5 to 200% by weight, based on the weight of the monomers.

34. The composition according to claim 31, wherein the ammonium polyphosphate is present in an amount from 25 to 150% by weight, based on the weight of the monomers.

35. A composition for producing poly(meth)acrylimide foams and moulding compositions having reduced flammability, comprising zinc sulphide.

36. The composition according to claim 35, wherein the zinc sulphide is present in an amount from 0.1 to 20% by weight, based on the weight of the monomers.

37. The composition according to claim 35, wherein the zinc sulphide is present in an amount from 0.5 to 10% by weight, based on the weight of the monomers.

38. The composition according to claim 35, wherein the zinc sulphide is present in an amount from 1 to 5% by weight, based on the weight of the monomers.

39. A composition for producing poly(meth)acrylimide foams and moulding compositions having reduced flammability, comprising zinc sulphide and ammonium polyphosphate.

40. The composition according to claim 39, wherein the zinc sulphide is present in an amount from 0.1 to 20% by weight, based on the weight of the monomers, and the ammonium polyphosphate is present in an amount from 1 to 300% by weight, based on the weight of the monomers.

41. The composition according to claim 39, wherein the zinc sulphide is present in an amount from 0.5 to 10% by weight, based on the weight of the monomers, and ammonium polyphosphate is present in an amount from 5 to 200% by weight, based on the weight of the monomers.

42. The composition according to claim 39, wherein the zinc sulphide is present in an amount from 1 to 5% by weight, based on the weight of the monomers, and the ammonium polyphosphate is present in an amount from 25 to 150% by weight, based on the weight of the monomers.

43. The composition according to claim 31, further comprising one or more flame retardants.

44. The composition according to claim 43, wherein the one or more flame retardants are one or more phosphorus compounds.

45. The composition according to claim 44, wherein
the one or more phosphorus compounds are selected from phosphines, phosphine oxides, phosphonium compounds, phosphonates, phosphites, phosphates, or mixtures thereof.

46. The composition according to claim 31, further comprising dimethyl methanephosphonate.

47. The composition according to claim 31, further comprising resorcinol bisdiphenylphosphate.

48. The composition according to one claim 31, further comprising an anti-settling agent.

49. The composition according to claim 48, wherein the anti-settling agent is a high molecular weight polymethyl methacrylate.

50. The composition according to claim 48, wherein the anti-settling agent is an Aerosil.

51. The composition according to claim 48, wherein the anti-settling agent is carbon black.

52. The composition according to claim 31, wherein the blowing agent is selected from an aliphatic alcohol having 3 to 8 carbon atoms, urea, monomethyl- or N,N′-dimethylurea, or formamide.

53. A moulding prepared from the composition according to claim 35.

54. A poly(meth)acrylimide foam obtained from polymerizing and foaming the composition according to claim 31.

55. A poly(meth)acrylimide foam obtained by foaming the composition according to claim 35.

56. A layered material comprising a layer of a poly(meth)acrylimide foam according to claim 54.

57. An automobile comprising the poly(meth)acrylimide foam according to claim 54.

58. A rail vehicle comprising the poly(meth)acrylimide foam according to claim 54.

59. A watercraft comprising the poly(meth)acrylimide foam according to claim 54.

60. An aircraft comprising the poly(meth)acrylimide foam according to clam 54.
